(19) United States
(12) Patent Application Publication
(10) Pub. No.: US 2009/0116000 A1
(43) Pub. Date: May 7, 2009

(54) FIBER OPTIC SHAPE DETERMINATION SYSTEM

(76) Inventors: JASON KIDDY, Gleen Dale, MD (US); Chris Baldwin, Laurel, MD (US); John Niemczuk, Kensington, MD (US)

Correspondence Address: HOLLAND & KNIGHT LLP, 10 ST. JAMES AVENUE, 11th Floor, BOSTON, MA, 02116-3889, US

(21) Appl. No.: 12/254,451

(22) Filed: Oct. 20, 2008

Related U.S. Application Data
(60) Provisional application No. 60/984,567, filed on Nov. 1, 2007.

(51) Int. Cl. G01N 21/00; F17D 5/00; E21B 47/00

(52) U.S. Cl. 356/73.1; 137/559; 175/50

(57) ABSTRACT

A fiber optic shape determination system having at least one optical fiber for placement within or along an elongated structure. The optical fiber defines an optical path for conveying an optical signal. The optical path manifests an interaction with the optical signal wherein the interaction occurs in a continuous fashion during the propagation of the optical signal along the optical path and produces a measurable response, the response conveying information about strain imparted to the optical fiber and a location along the optical fiber at which the strain occurs. The shape determination system also has a measurement component coupled to the optical fiber to sense the response and for determining the strain applied at different locations along the fiber and for deriving a shape of optic fiber, accordingly.

### CROSS-REFERENCE TO RELATED APPLICATION

This application claims the benefit under 35 USC 119(e) of U.S. Provisional Patent Application No. 60/984,567 filed on Nov. 1, 2007 and is hereby incorporated by reference herein.

### FIELD OF THE INVENTION

The present invention relates to an apparatus and methods for determining the shape of a body. In addition, the invention also extends to novel applications where an optical fiber shape determination system can be used to assess the shape of an elongated flexible body.

### BACKGROUND OF THE INVENTION

A number of applications exist where the shape of an elongated body needs to be determined with a relative degree of precision. For example, the Chen U.S. Pat. No. 6,256,090 discusses a towed sonar array provided with a fiber optic shape determination system. The fiber optic shape determination system has a plurality of optical fibers, each optical fiber being provided with Bragg gratings at known locations along their lengths. Optical signals interrogate the gratings and can derive for each grating the degree of strain induced in the grating. Since the optical fiber is attached to the towed sonar array, motions of the towed sonar array will bend the optical fiber, thus giving rise to a stress pattern along the fibers. The stress pattern is indicative of the shape that the optical fiber has acquired. By processing the responses of the Bragg gratings it is, therefore possible to compute the shape of the towed sonar array on the basis of the stress pattern.

### SUMMARY OF THE INVENTION

As embodied and broadly described herein, the invention provides a fiber optic shape determination system having at least one optical fiber for placement within or along an elongated structure. The optical fiber defines an optical path for conveying an optical signal. The optical path manifesting an interaction with the optical signal wherein the interaction:
occurs in a continuous fashion during the propagation of the optical signal along the optical path;
producing a measurable response, the response conveying information about strain imparted to the optical fiber and a location along the optical fiber at which the strain occurs;

The shape determination system has a measurement component coupled to the optical fiber to sense the response and for determining the strain applied at different locations along the fiber and for deriving a shape of optic fiber accordingly.

As embodied and broadly described herein the invention provides a fiber optic shape determination system having an array of Fabry-Perot strain sensors for placement within or along an elongated structure and optical paths leading to the strain sensors allowing to optically interrogate the strain sensors. A measurement component is coupled to the optical paths for interrogating each strain sensor to determine a strain induced on the sensor and for deriving a shape of the array on the basis of the strain induced on each sensor and a sensor location map identifying a position of each sensor on the elongated structure.

As embodied and broadly described herein the invention provides a fiber optic shape determination system, having an array of strain sensors for placement within or along an elongated structure and optical paths leading to the strain sensors allowing to optically interrogate the strain sensors. Each strain sensor altering an intensity of an optical signal according to strain induced on the sensor. A measurement component coupled to the optical paths for interrogating each strain sensor to determine a strain induced on the sensor and deriving a shape of the array on the basis of the strain induced on each sensor and a sensor location map identifying a position of each sensor on the elongated structure.

As embodied and broadly described herein, the invention also provides a pipeline having an elongated conduit defining a flow path characterized by a direction of flow along which liquid is transported through the elongated conduit. A fiber optic measurement component is provided to determine the shape of the elongated conduit. The fiber optic measurement component includes at least one optical fiber defining an optical path for conveying an optical signal. The optical fiber is mounted to the elongated conduit and extends along the elongated conduit in the direction of flow. The optical path manifests an interaction with the optical signal, which produces a measurable response. The response conveys information about strain imparted to the optical fiber and a location along the optical fiber at which the strain occurs. A measurement component is coupled to the optical fiber to sense the response and to determine the strain applied at different locations along the fiber and to derive a shape of the elongated conduit, accordingly.

As embodied and broadly described herein the invention also provides a helicopter blade that has an elongated blade member having a longitudinal axis. A fiber optic measurement component is provided to determine the shape of the elongated blade member. The fiber optic measurement component including at last one optical fiber defining an optical path for conveying an optical signal mounted to the elongated blade member and extending along the longitudinal axis. The optical path manifests an interaction with the optical signal which produces a measurable response. The response conveys information about strain imparted to the optical fiber and a location along the optical fiber at which the strain occurs. A measurement component is coupled to the optical fiber to sense the response and to determine the strain applied at different locations along the fiber and to derive a shape of the elongated blade member, accordingly.

As embodied and broadly described herein the invention also provides a wind turbine blade that has an elongated blade member having a longitudinal axis. A fiber optic measurement component is provided to determine the shape of the elongated blade member. The fiber optic measurement component including at least one optical fiber defining an optical path for conveying an optical signal mounted to the elongated blade member and extending along the longitudinal axis. The optical path manifests an interaction with the optical signal which produces a measurable response. The response conveys information about strain imparted to the optical fiber and a location along the optical fiber at which the strain occurs. A measurement component is coupled to the optical fiber to sense the response and to determine the strain applied at different locations along the fiber and to derive a shape of the elongated blade member, accordingly.

As embodied and broadly described herein the invention also provides an aircraft wing that has an elongated wing member having a longitudinal axis. A fiber optic measurement component is provided to determine the shape of the elongated wing member. The fiber optic measurement component including at least one optical fiber defining an optical path for conveying an optical signal mounted to the elongated wing member and extending along the longitudinal axis. The optical path manifests an interaction with the optical signal occurring in a continuous fashion which produces a measurable response. The response conveys information about strain imparted to the optical fiber and a location along the optical fiber at which the strain occurs. A measurement component is coupled to the optical fiber to sense the response and to determine the strain applied at different locations along the fiber and to derive a shape of the elongated wing member, accordingly.

As embodied and broadly described herein the invention also provides a maritime vessel having a hull member and a fiber optic measurement component to determine a shape of the hull. The fiber optic measurement component including at last one optical fiber defining an optical path for conveying an optical signal mounted to the hull. The optical path manifesting an interaction with the optical signal, the optical path producing a measurable response, the response conveying information about strain imparted to the optical fiber and a location along the optical fiber at which the strain occurs. A measurement component is coupled to the optical fiber to sense the response and to determine the strain applied at different locations along the fiber and to derive a shape of the hull, accordingly.

As embodied and broadly described herein the invention further provides a borehole drilling device having an elongated drill having a direction of longitudinal extent to bore a hole in the ground. A fiber optic measurement component is provided to determine a shape of the drill as it bores the hole, the fiber optic measurement component including at least one optical fiber defining an optical path for conveying an optical signal mounted to the elongated drill and extending along the direction of longitudinal extent. The optical path manifests an interaction with the optical signal which produces a measurable response, the response conveying information about strain imparted to the optical fiber and a location along the optical fiber at which the strain occurs. A measurement component is coupled to the optical fiber to sense the response and to determine the strain applied at different locations along the fiber and to derive a shape of the elongated drill and of the bore being drilled, accordingly.

As embodied and broadly described herein the invention further includes an apparatus for determining the shape of borehole including an elongated member having a direction of longitudinal extent for insertion into the borehole and a fiber optic measurement component to determine a shape of the borehole after the elongated member has been inserted therein. The fiber optic measurement component including at last one optical fiber defining an optical path for conveying an optical signal mounted to the elongated member and extending along the direction of longitudinal extent. The optical path manifests an interaction with the optical signal, which produces a measurable response, the response conveying information about strain imparted to the optical fiber and a location along the optical fiber at which the strain occurs. A measurement component is coupled to the optical fiber to sense the response and to determine the strain applied at different locations along the fiber and to derive a shape of the borehole, accordingly.

### BRIEF DESCRIPTION OF THE DRAWINGS

A detailed description of examples of implementation of the present invention is provided hereinbelow with reference to the following drawings, in which:

FIG. 1 is schematical view of a fiber optic shape determination system according to a non-limiting example of implementation of the invention;

FIG. 2 is a graph illustrating the principle of Brillouin scattering;

FIG. 3 is a block diagram of a measurement component for determining a stress profile in the optical fiber;

FIG. 4 is a variant of the measurement component shown in FIG. 3;

FIG. 5 is a cross sectional view of the elongated body shown in FIG. 1 to which are attached multiple optical fibers, allowing to determine the shape of the elongated body in three dimensions;

FIG. 6a is a variant of the optical shape determination system shown in FIG. 1;

FIG. 6b is another variant of the optical shape determination system shown in FIG. 1;

FIG. 7 is a perspective view of a helicopter blade on which the optic fiber shape determination system can be used to determine its shape;

FIG. 8 is a perspective view of wind turbine on which the optic fiber shape determination system can be used to determine the shape of its blades;

FIG. 9 is a perspective view of a pipeline on which the optic fiber shape determination system can be used to determine its shape;

FIG. 10 is a perspective sectional view of that shows a drill in the process of boring a hole in the ground on which the optic fiber shape determination system can be used to determine the borehole shape;

FIG. 11 shows the borehole of FIG. 10 in greater detail; and

FIG. 12 is a perspective view of a maritime vessel on which the optic fiber shape determination system can be used to determine the shape the vessel's hull.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

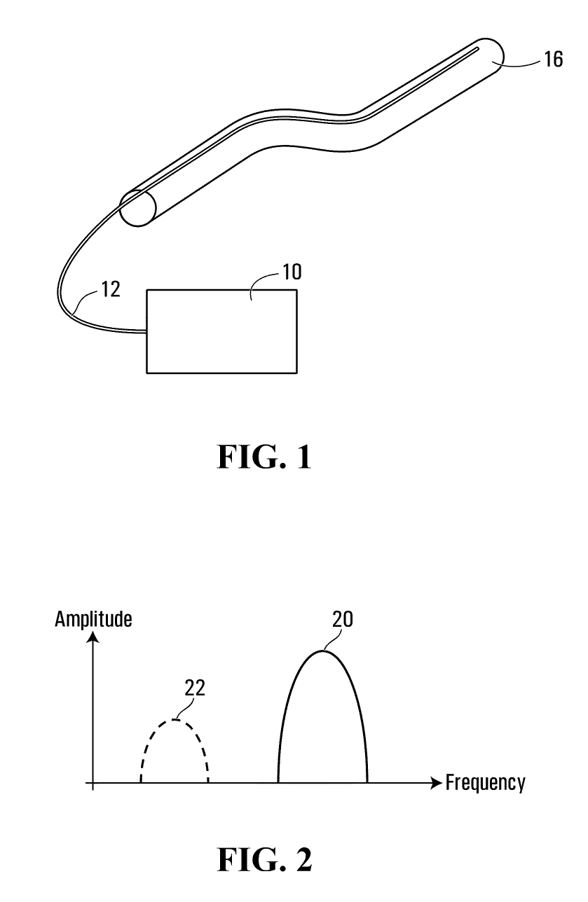

FIG. 1 is a schematical view of one example of implementation of a fiber optic shape determination system according to a non-limiting example of implementation of the invention. The fiber optic shape determination system 10 includes at least one optic fiber 12 that connects to a measurement component 14. The optic fiber 12 is mounted to an elongated body 16 whose shape is to be determined. The elongated body 16 is flexible and can acquire different configurations in three dimensions. The fiber optic shape determination system 10 can be used to sense that a shape change has occurred and can also be used to determine what the shape of the flexible body 16 actually is.

The optic fiber 12 is mounted to the body and runs along its direction of longitudinal extent. In this fashion, as the elongated body undergoes movements, for instance it flexes at one or more locations, the optic fiber 12 is flexed as well. The flexing movement in the optic fiber 12 produces localized strain that alters its optical transmission parameters.

The measuring component 10 is coupled to the optical fiber 12 in order to introduce in the optical fiber 12 an optical interrogation signal. The measuring component 10 also reads from the optical fiber 12 the response to the interrogation signal. Since the optical interrogation signal is altered by the localized strains that are induced in the optical fiber 12 by the elongated body 16 it is possible to resolve those strains into shape information.

The sensing of the strain induced in the optical fiber 12 is made by measuring the back scattered light produced as the optical interrogation signal propagates along the optical fiber 12. Without intent of being bound by any particular theory, scattering in general and back scattering in particular arises as a result of inhomogeneities in the refractive index in the optical path or due to acoustic waves known as phonons. Different components of the back-scattered light can be identified, such as Raleigh, Raman and Brillouin scattering. The Brillouin scattering induces a Doppler frequency shift of the scattered light. This is usually referred to as the spontaneous Brillouin scattering.

The graph at FIG. 2 illustrates the Brillouin scattering principle. The reference numeral 20 designates the interrogation signal that is being injected into the optical fiber 12. In this example, the interrogation signal 20 is in the form of a pulse. As the pulse propagates along the optical fiber 12 it interacts with the optical path. This interaction produces a measurable back scattering response shown at 22. The back scattering response propagates in an opposite direction with relation to the direction of travel of the optical interrogation pulse. Generally the response is downshifted in frequency relative to the frequency of the optical interrogation pulse which allows distinguishing the response from the optical interrogation pulse itself.

The graph shown at FIG. 2 depicts a situation where the back scattering phenomenon is homogeneous along the length of the optical fiber 12. In other words, as the optical interrogation pulse travels along the optical fiber, the interaction with the optical path remains the same. Accordingly, the frequency shift between the response and the optical interrogation signal does not change.

In the case when strain is induced in the optical fiber 12, which can arise if the optical fiber 12 is bent or stretched or if the ambient temperature changes, the interaction will also change. The bend, stretch or temperature change produces alterations in the optical path and those alterations affect the interaction between the optical path and the optical interrogation pulse. Such interaction changes manifest themselves as frequency shifts of the response. Accordingly the frequency shift between the response and the frequency of the optical interrogation pulse constitutes an indicator of the localized strain that is induced in the optical fiber 12.

It should be noted that the interaction between the optical interrogation signal and the optical path occurs in a continuous fashion as the optical interrogation signal propagates along the optical fiber 12. This is to be distinguished from prior art designs where the interaction is of discrete nature and occurs only at specific locations in the optical fiber where sensors are placed. Those sensors can be Bragg gratings. Accordingly, when the optical interrogation signal propagates along the optical fiber it produces a response only when it encounters a Bragg grating. No response is produced between gratings. There is one major downside to this design. First, strain induced in the optical fiber can be sensed only if it spans the location of a Bragg grating. If the strain affects the optical path between two Bragg gratings, it may not be sensed reliably or accurately enough. This potential problem can be alleviated by placing enough Bragg grating in the optical fiber such that they are closer to one another, however, Bragg gratings are expensive and this solution would increase the cost of the fiber optic shape determination system.

By using a continuous interaction system of the type described earlier there is no necessity to provide any sensors in the optical fiber 12. In fact, the optical fiber 12 is a standard optical fiber without any modifications or changes required.

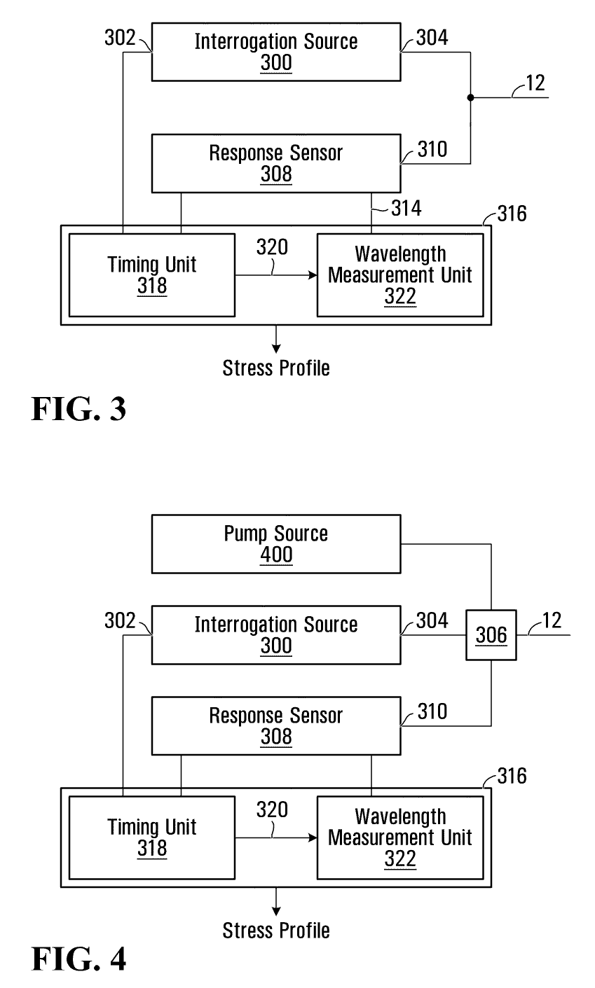

FIG. 3 is a more detailed block diagram of the measuring component 10. The measuring component 10 includes several components which in practice will be controlled via a computer. The computer is not shown for the purpose of clarity, however it should be understood that many of the functions described below can be implemented on a suitable computer platform.

The measuring component 10 includes in interrogation source 300 that generates the optical interrogation signal. The interrogation source 300 can be a laser. The interrogation source 300 has an input 302 at which is received a control signal used to trigger the interrogation source 300. The interrogation source also has an output 304 via which the optical interrogation signal is released. In a specific and non limiting example of implementation, the optical interrogation signal is in the form of pulse. The duration, intensity and wavelength (frequency) of the pulse can be determined according to the intended application.

A response sensor 308 has an input 310 connected to the coupler 306 to sense the response produced by the optical interrogation signal. The response sensor 308 is an opto electronic device that detects the presence of the response at the input 310 and also determines the wavelength (frequency) of the response. The response sensor 308 has an output 314. Information about the wavelength (frequency) of the response is delivered via the output 314.

A processing component 316 receives the wavelength information from output 314. Specifically, the processing component 316 includes a timing unit 318 and a wavelength measurement unit 322. The timing unit 318 has a control output 320 that drives the interrogation source 300 and also a control output 320 that drives the wavelength measurement unit 322. When a control signal is produced by the return time measurement unit 318, the interrogation source triggers an optical interrogation pulse that is injected into the optical fiber 12. At the same time a high precision timing circuit is triggered to count time. Since the travel speed of the optical interrogation pulse in the optical fiber 12 is known and the speed of travel of the response is also known, it is possible to determine, on the basis of the time span between the trigger of the optical interrogation pulse and the reading of the response the area of the optical path (the distance from the extremity of the optical fiber 12 at which the optical interrogation pulse in injected and where the response is read) that has produced the response.

For instance if it is desired to read the response produced by the area of the optical fiber 12 that is 1000 feet from the extremity of the optical fiber, the timing unit 318 counts time, once the control signal to trigger the optical interrogation pulse has been issued, that corresponds to the time necessary for the optical interrogation pulse to travel 1000 feet down the optical fiber 12, plus the time it takes the response to travel back the 1000 feet distance to the extremity of the optical fiber 12. As indicated earlier, since the speed of the travel of the optical interrogation pulse and of the response are known, it is possible to compute the duration of the time interval necessary to get a reading from a desired location on the optical fiber 12.

Once the time duration computed by the timing unit 318 has passed, a control signal is issued by the timing unit 318 on control output 320. At that point the wavelength measurement unit 322 takes a reading of the wavelength of the response that is produced at the output 314 of the response sensor. The wavelength information captured by the wavelength measurement unit indicates the intensity of the strain applied at the location of the optical fiber 12 where the measurement is being read. The position of that location, in terms of distance measured along the optical fiber 12 is determined on the basis of the time interval between the triggering of the optical interrogation pulse and the wavelength reading.

The same operation can be repeated to measure the strain induced on the optical fiber 12 but at a different position, by changing the time interval. This can be done by triggering a new optical interrogation pulse and extending the time interval in order to obtain a reading further down the optical fiber 12. The different data points obtained in this fashion can be used to create a stress profile for the optical fiber 12. The stress profile correlates the localized strains to the respective positions along the optical fiber where those strains have been sensed.

The resolution of the stress profile, in other words, how close can the measurement points along the optical fiber 12 be to one another depends largely on the precision of the timing unit 318. With a highly accurate timing unit, of a type that is commercially available, it is possible to read the strains at steps as low as 10 inches.

FIG. 4 shows a variant of the measurement component 10. The main distinction with the unit described in connection with FIG. 3 is the use of a pump source 400 that allows creating a Stimulated Brillouin Scattering (SBS) interaction. More specifically, the pump source produces a laser beam that is introduced into the optical fiber 12 via the coupler 306. If the intensity of the beam is sufficiently high its electric field will generate acoustic vibrations in the optical path via electrostriction. This can generate Brillouin scattering that can be effectively amplified by injecting in the optical fiber 12 an optical interrogation pulse produced by the source 300. The SBS is advantageous in that it produces a stronger response that is easier to pick up and process.

The scattering systems described in connection with FIGS. 1, 3 and 4 have a number of advantages over other types of sensing methods. In the case of an SBS system, it can be employed over extremely long distances, such as in excess of 75 km, by using suitable amplifiers. Also it provides a fairly low cost system that does not require a special optical fiber provided with multiple sensors along its length.

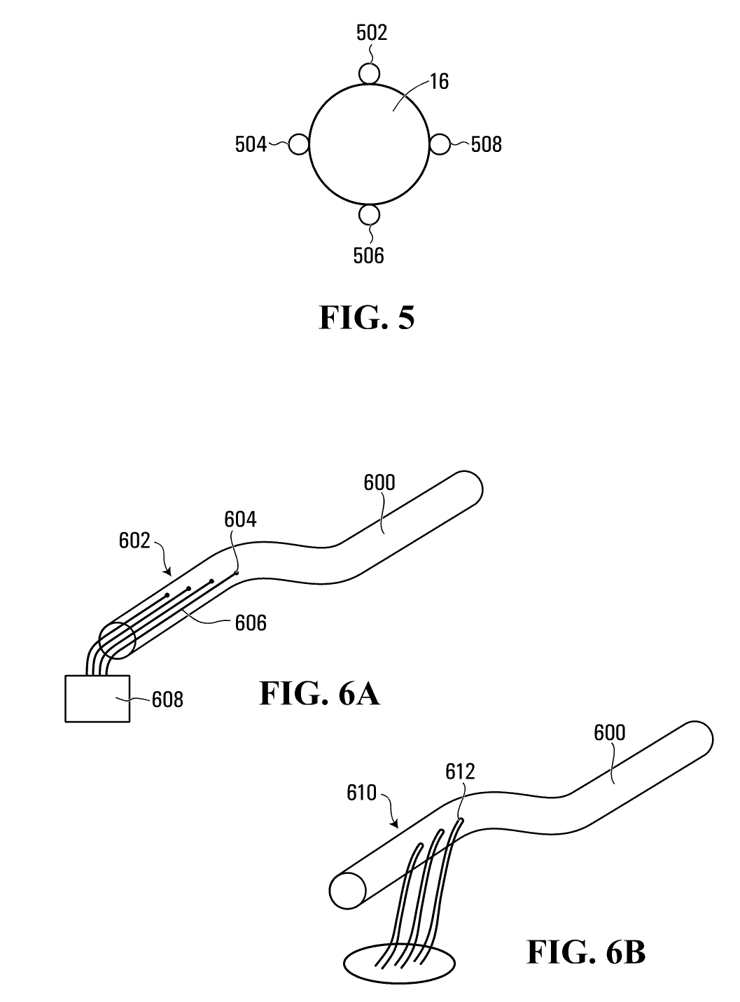

The systems described earlier can generate the stress profile of a unique optical fiber. In order to determine the shape of the elongated body more than one optical fiber may be required. FIG. 5 is a longitudinal cross-sectional view of the elongated body 16, showing the possible placement of multiple optical fibers 12 allowing determining the occurrence of bends in different planes. Specifically, the outside surface of the elongated flexible body 16 is provided with four optical fibers 502, 504, 506 and 508. Those optical fibers 502, 504, 506 and 508 are secured to the elongated flexible body 16 on its outside surface and they all run along its direction of longitudinal extent. The optical fibers 502, 504, 506 and 508 are parallel to one another as they run along the elongated flexible body 16. Alternatively, the optical fibers may be helixed along the structure

Collectively, the stress profiles for the optical fibers 502, 504, 506 and 508 can be resolved in a shape by using strain-to-shape resolution techniques of the type described in the Chen U.S. Pat. No. 6,256,090. Three of these optical fibers are used to determine the shape of the elongated body 16, while the fourth optical fiber, in conjunction with the three others provides torsion measurements to account for twist. Accordingly, a optic fiber shape determination system that uses four optical fibers, such as shown in FIG. 5, will have a measurement component dedicated to each optical fiber 502, 504, 506 and 508 and an additional processing entity to run the strain-to-shape resolution algorithm.

FIG. 6a illustrates a variant of the optic fiber shape determination system. This variant uses an array of Fabry-Perot sensors to determine the degree of strain acting on the surface of an elongated flexible body. In turn, the strain information can be resolved into shape of the elongated flexible body.

More specifically, the outside surface of the elongated flexible body is provided with an array of Fabry-Perot sensors 602. Each sensor 604 detects strain. Bending or elongation of the elongated flexible body 600 at an area where a sensor 604 is located will produce such strain that the sensor 604 can pick up. Fabry-Perot sensors are generally well known in the art and they operate on the basis of optical interferometry.

Each sensor 604 is coupled to a dedicated optical fiber 606 that carries the interrogation signal and returns the response signal. All the optical fibers connect to a measurement component 608 that generates the interrogation signals and also that reads the responses from the sensors 604. The advantage of using a Fabry-Perot sensor resides in its response speed and high resolution. The sensors 604 can thus provide strain information when the elongated flexible body 600 moves very quickly. This can be the case of machine components that are subjected to flexing movements or vibration movements occurring rapidly.

The sensors 604 are distributed over the surface of the elongated flexible body 600 in a way to form an array covering the entirety of the surface or only areas of interest. The number of sensors 604 in the array will determine the resolution of the system.

Another variant is shown in FIG. 6b. The elongated body 600 has an array of sensors 610, having individual sensors 612, where each individual sensor 612 is an intensity based sensor. Such intensity based sensor alters the intensity of an optical signal according to the strain that is induced on the optical fiber. In one specific example, the sensor is in the form of an optical fiber loop, where the looped part is the sensing part. When the elongated flexible body 600 flexes, the flexing motion induces strain in the sensors 612 that in turn alters the intensity of the optical signal traveling through the optical fiber. The basic instrumentation for this type of sensor includes an optical signal source and a photodetector. The sensor itself may be designed as an optical bend loss device, an air gap, a polarization filter, among others.

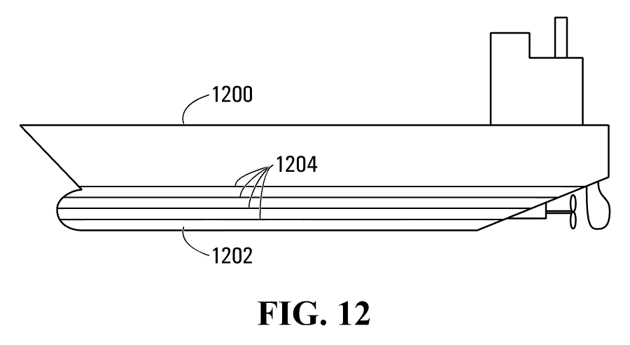

FIG. 12 illustrates a specific example of an application for the fiber optic shape determination system described earlier. FIG. 12 illustrates a maritime vessel 1200 that has a hull 1202. It is desirable to determine the shape of the hull or portions thereof as it may be flexing or bending due to forces acting on it. For instance in heavy seas or in the presence of ice a portion of the hull 1202 may bend or flex. Determining the degree of flex is advantageous to reduce the possibility of hull damage. The fiber optic shape determination system is placed either on the outer surface of the hull or on the inside surface. Placement over the inside surface is generally better since the equipment is protected from the elements. The number of optical fibers that are laid over the surface of the hull can vary depending upon the hull portions to be monitored. In the example shown four optical fibers 1204 run lengthwise of the hull on each side thereof. The optical fibers 1204 are placed on the lower section of the hull the monitor the hull portion that resides in water and that may be subjected to most efforts in use.

The fiber optic shape determination system can also be used to monitor the hull stability over time and detect any permanent shifts or bends that may need to be repaired.

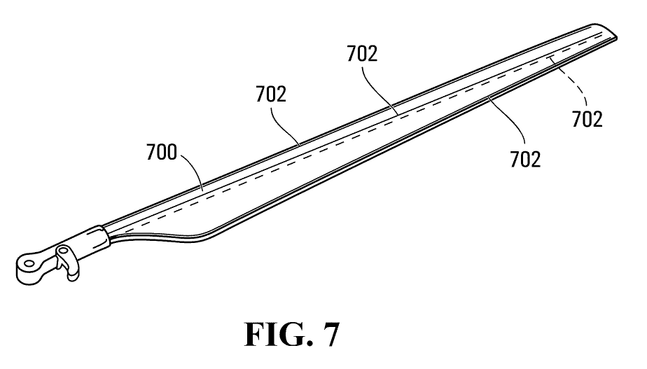

Another application of the fiber optic shape determination system is shown in FIG. 7 that illustrates a helicopter blade 700. The fiber optic shape determination system is provided to determine the shape of the helicopter blade, while the blade 700 is in use. The shape information that is generated can be used for:
sensing deformations that may exceed the physical limits of the blade 700 and indicate to the pilot to take a corrective action;
precisely track the how the blade 700 “ages” by counting flexures or deformations that the blade 700 sees in use. In such case the “aging” expressed in terms of flexure cycles, can be used to determine if the blade 700 can remain in service or should be replaced
provide real time measurement of the blade deformation in flight for flight control purposes.

The fiber optic shape determination system uses four optical fibers 702 that run along the longitudinal axis of the blade 700. Specifically, one of the optical fibers 702 extends along the leading edge of the blade 700, another along the trailing edge of the blade 700 and the two others along the top and bottom surfaces of the blade 700. Obviously, other placement patterns are possible without departing from the spirit of the invention.

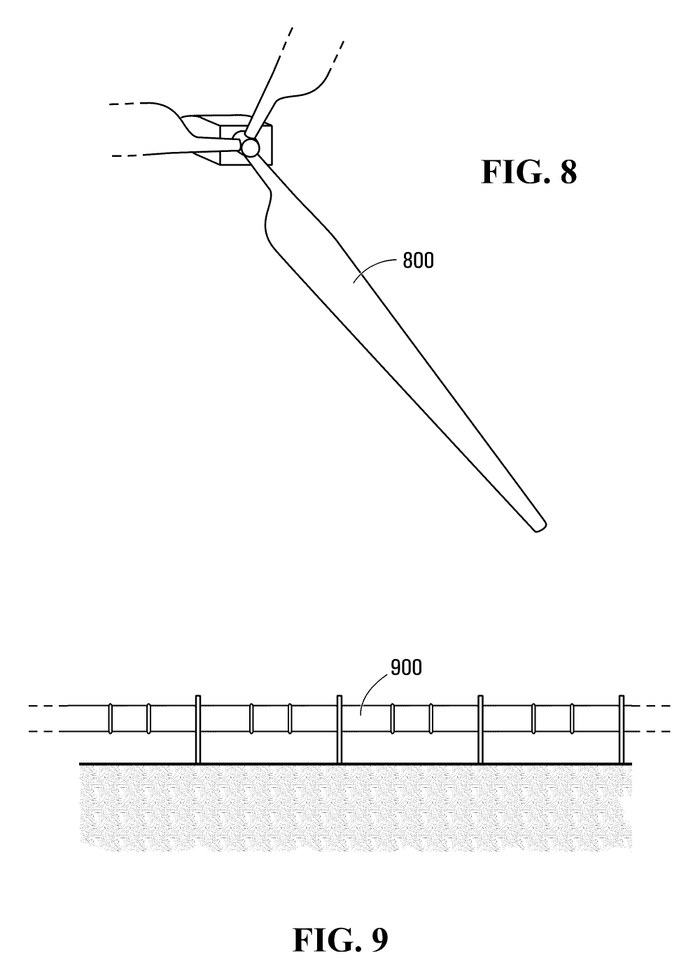

FIG. 8 is yet another example of application of the fiber optic shape determination system. In this application the fiber optic shape determination system is installed on a blade 800 of a wind turbine. The optical fiber placement can be same as described in connection with FIG. 7. The purpose for using the fiber optic shape determination system on a wind turbine blade can be to detect dangerous conditions but also to allow running the wind turbine more efficiently. For instance the shape of the blade 800 may be used to sense whether the wind turbine operates at peak efficiency. If the wind turbine does not operate at peak efficiency then the operating conditions of the wind turbine may be modified accordingly such as by changing the speed at which the wind turbine rotates or changing the pitch of the blades 800.

Another example of application is shown in FIG. 9 where the fiber optic shape determination system can be used to monitor the shape of a pipeline 900. Note that while the drawing shows an above ground pipeline, the same principle would apply to an underground or underwater one. The optical fibers of the fiber optic shape determination system are laid over the pipeline such that they run along the direction of longitudinal extent. The fiber optic shape determination system can be used to detect any ground shifts that may be sufficiently important to impair the integrity of the pipeline 900 and thus create a potential leak.

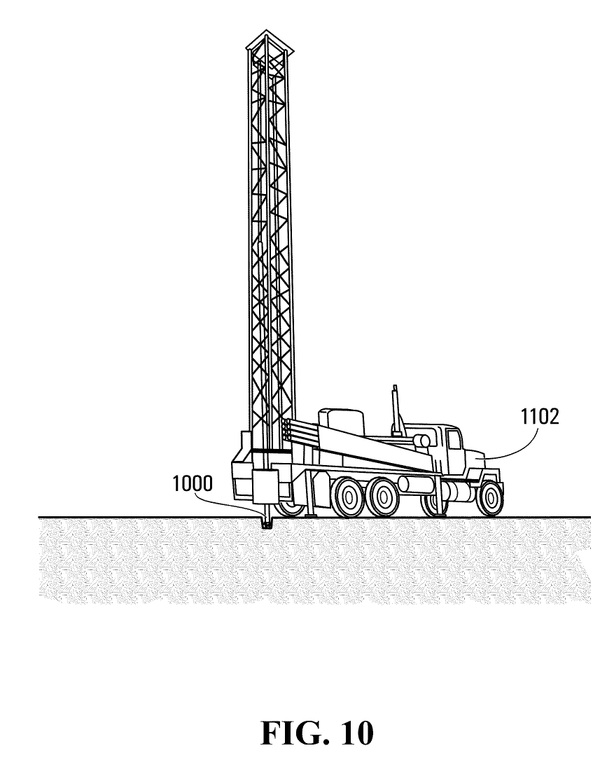

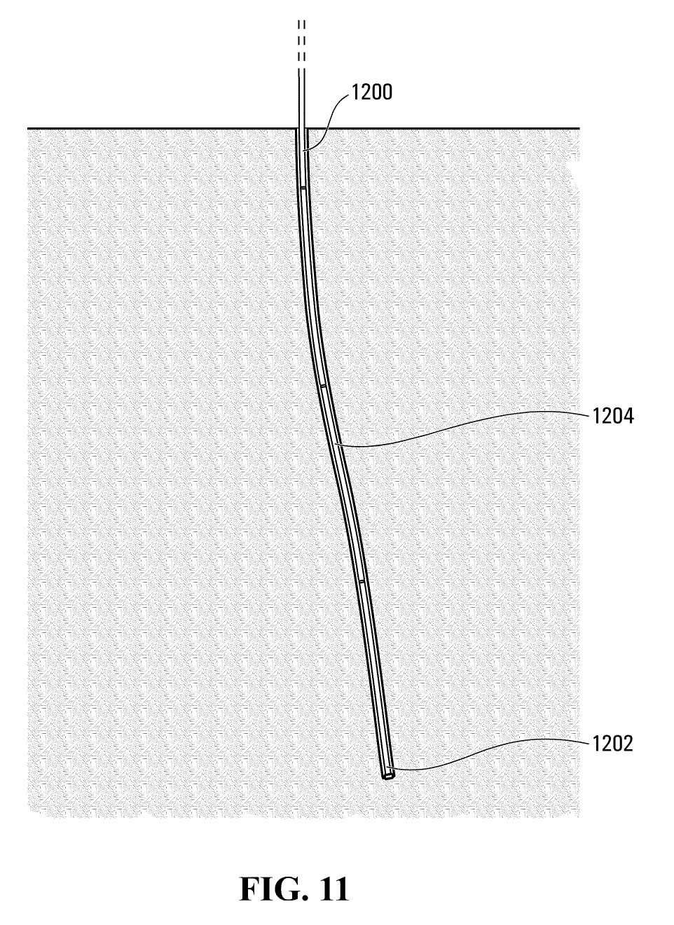

FIGS. 10 and 11 illustrate yet another possible application of the fiber optic shape determination system. In this example the fiber optic shape determination system is used to determine the shape of a borehole, such as an oil well borehole for instance. The drill 1000 that creates the borehole is provided with optical fibers along its length such that as the drill progressively penetrates into the ground, the optical fibers are inserted therein. Accordingly, as the operator of the drill has, in real time, information about the shape of the borehole. As FIG. 11 illustrates, the borehole 1200 may not always be drilled straight, especially if it reaches important depths. Information on the precise shape of the borehole allows guiding the drill appropriately such as to be able to reach a precise underground position.

More specifically, the drill 1000 has two main portions, namely a drill head portion 1202 and a tail portion 1204. The drill head portion 1202 is the component of the drill 1000 that performs the boring operation in the rock or soil. Typically, the boring operation is performed by rotating abrasion or fluid jets. The tail portion 1204 is the component of the drill 1000 that connects the drill head portion 1202 to the surface, typically to the drill rig 1102 (shown in FIG. 10). The tail portion 1204 is flexible.

The fiber optic shape determination system can be installed on the drill such that the optical fibers span the drill head portion 1202 and the tail portion 1204. In this fashion, the fiber optic shape determination system can report in real time the shape of the drill 1000, which reflects the shape of the borehole. Since the measurement is effected in real time and provided as the drill head 1000 performs the boring operation, it provides information that can be used to steer the drill head portion 1202 and thus control the orientation of the borehole 1200.

In a possible variant, the shape of the borehole 1200 can be determined while the hole is being drilled by only measuring the shape of the drill head portion 1202. As the drill head portion 1202 proceeds deeper, the previously measured shape can be stored and concatenated to the overall borehole shape. In this manner only the drill head portion 1202 must be instrumented with the shape estimation system to attain a measurement of the entire borehole shape.

In yet another possible variant, the shape of the borehole 1200 can be determined once the borehole 1200 has been drilled. After the drilling operation is completed the drill is removed form the borehole 1200 and any suitable elongated and flexible body to which are mounted the optical fibers of the fiber optic shape determination system is inserted in the borehole 1200. As the body is inserted in the borehole 1200 it acquires the shape of the borehole 1200 and that shape can be determined by the fiber optic shape determination system.

Although various embodiments have been illustrated, this was for the purpose of describing, but not limiting, the invention. Various modifications will become apparent to those skilled in the art and are within the scope of this invention, which is defined more particularly by the attached claims.

1) A fiber optic shape determination system, comprising:
a) at least one optical fiber for placement within or along an elongated structure;
b) said optical fiber defining an optical path for conveying an optical signal, said optical path manifesting an interaction with the optical signal, said interaction:
i) occurring in a continuous fashion during the propagation of the optical signal along the optical path;
ii) producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of optic fiber on the basis of said determining.

2) A fiber optic shape determination system as defined in claim 1, wherein the optical signal is pulsed.

3) A fiber optic shape determination system as defined in claim 2, wherein the interaction includes scattering.

4) A fiber optic shape determination system as defined in claim 3, wherein the interaction produced back-scattering, said measurement component sensing the back-scattering.

5) A fiber optic shape determination system as defined in claim 4, wherein the interaction includes Brillouin scattering.

6) A fiber optic shape measuring system as defined in claim 5, wherein the interaction includes stimulated Brillouin scattering.

7) A fiber optic shape determination system as defined in claim 5, wherein said measurement component uses frequency information in the back-scattering to derive information about strain induced in the optical fiber.

8) A fiber optic shape determination system as defined in claim 7, wherein said measurement component used information about time of travel of optical pulses in the optical fiber to derive information about the location along the fiber at which the strain occurs.

9) A fiber optic shape determination system as defined in claim 1, including at least three optical fibers for placement within on along the elongated structure, said measurement component sensing the responses produced by each optical fiber to derive a shape of the elongated structure in three dimensions.

10) A fiber optic shape determination system as defined in claim 1, wherein the elongated structure is selected from the group consisting of borehole, drill for drilling a borehole, pipeline, helicopter blade, towed sonar array, tether line, ship hull, wind turbine blade, seismic streamer.

11) A fiber optic shape determination system, comprising:
a) an array of Fabry-Perot strain sensors for placement within or along an elongated structure;
b) optical paths leading to said strain sensors allowing to optically interrogate said strain sensors;
c) a measurement component coupled to the optical paths for:
i) interrogate each strain sensor to determine a strain induced on the sensor;
ii) deriving a shape of the array on the basis of:
(1) the strain induced on each sensor;
(2) a sensor location map identifying a position of each sensor on the elongated structure.

12) A fiber optic shape determination system, comprising:
a) an array of strain sensors for placement within or along an elongated structure;
b) optical paths leading to said strain sensors allowing to optically interrogate said strain sensors, each strain sensor altering an intensity of an optical signal according to strain induced on the sensor;
c) a measurement component coupled to the optical paths for:
i) interrogate each strain sensor to determine a strain induced on the sensor;
ii) deriving a shape of the array on the basis of:
(1) the strain induced on each sensor;
(2) a sensor location map identifying a position of each sensor on the elongated structure.

13) A pipeline, comprising:
a) an elongated conduit defining a flow path having direction of flow along which liquid is transported through said elongated conduit;
b) a fiber optic measurement component to determine a shape of said elongated conduit, said fiber optic measurement component including:
i) at least one optical fiber defining an optical path for conveying an optical signal mounted to said elongated conduit and extending along said elongated conduit along the direction of flow,
ii) said optical path manifesting an interaction with the optical signal, said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the elongated conduit on the basis of said determining.

14) A pipeline as defined in claim 13, including three or more optical fibers extending along said elongated conduit along the direction of flow, said three of more optical fibers allowing to derive a three dimensional shape of said elongated conduit.

15) A pipeline as defined in claim 14, wherein said pipeline is above ground.

16) A pipeline as defined in claim 14, wherein said pipeline is underground.

17) A pipeline as defined in claim 14, wherein said pipeline is underwater.

18) A helicopter blade, comprising:
a) an elongated blade member having a longitudinal axis;
b) a fiber optic measurement component to determine a shape of said elongated blade member, said fiber optic measurement component including:
i) at least one optical fiber defining an optical path for conveying an optical signal mounted to said elongated blade member and extending along said longitudinal axis,
ii) said optical path manifesting an interaction with the optical signal occurring in a continuous fashion during the propagation of the optical signal along the optical path;
iii) said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the elongated blade member on the basis of said determining.

19) A helicopter blade as defined in claim 18, including three or more optical fibers extending along said elongated blade member along said longitudinal axis, said three of more optical fibers allowing to derive a three dimensional shape of said elongated blade member.

20) A wind turbine blade, comprising:
a) an elongated blade member having a longitudinal axis;
b) a fiber optic measurement component to determine a shape of said elongated blade member, said fiber optic measurement component including:
i) at least one optical fiber defining an optical path for conveying an optical signal mounted to said elongated blade member and extending along said longitudinal axis,
ii) said optical path manifesting an interaction with the optical signal, said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the elongated blade member on the basis of said determining.

21) A wind turbine blade as defined in claim 20, including three or more optical fibers extending along said elongated blade member along said longitudinal axis, said three of more optical fibers allowing to derive a three dimensional shape of said elongated blade member.

22) A maritime vessel, comprising:
a) an hull member;
b) a fiber optic measurement component to determine a shape of said hull, said fiber optic measurement component including:
i) at least one optical fiber defining an optical path for conveying an optical signal mounted to the hull,
ii) said optical path manifesting an interaction with the optical signal, said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the hull on the basis of said determining.

23) A maritime vessel as defined in claim 22, including three or more optical fibers extending along a longitudinal axis of said hull, said three of more optical fibers allowing to derive a three dimensional shape of said hull.

24) A borehole drilling device, comprising:
a) an elongated drill having a direction of longitudinal extent to bore a hole in the ground;
b) a fiber optic measurement component to determine a shape of said drill as it bores the hole, said fiber optic measurement component including:
i) at least one optical fiber defining an optical path for conveying an optical signal mounted to said elongated drill and extending along the direction of longitudinal extent,
ii) said optical path manifesting an interaction with the optical signal, said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the elongated drill and of the bore being drilled on the basis of said determining.

25) A borehole drilling device as defined in claim 24, including three or more optical fibers extending along a longitudinal axis of said elongated drill, said three of more optical fibers allowing to derive a three dimensional shape of said elongated drill and of the borehole as it is being drilled.

26) A borehole as defined in claim 25, wherein the borehole is a well bore.

27) An apparatus for determining the shape of borehole, comprising:
a) an elongated member having a direction of longitudinal extent for insertion into the borehole;
b) a fiber optic measurement component to determine a shape of said borehole after said elongated member has been inserted therein, said fiber optic measurement component including:
i) at least one optical fiber defining an optical path for conveying an optical signal mounted to said elongated member and extending along the direction of longitudinal extent,
ii) said optical path manifesting an interaction with the optical signal, said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the borehole on the basis of said determining.

28) An aircraft wing, comprising:
a) an elongated blade member having a longitudinal axis;
b) a fiber optic measurement component to determine a shape of said elongated blade member, said fiber optic measurement component including:
i) at least one optical fiber defining an optical path for conveying an optical signal mounted to said elongated blade member and extending along said longitudinal axis,
ii) said optical path manifesting an interaction with the optical signal occurring in a continuous fashion during the propagation of the optical signal along the optical path;
iii) said optical path producing a measurable response, the response conveying information about strain imparted to the optical fiber and a location along the optical fiber at which the strain occurs;
c) a measurement component coupled to the optical fiber to sense the response and for:
i) determining the strain applied at different locations along the fiber;
ii) deriving a shape of the elongated blade member on the basis of said determining.
